(19) United States
(12) Patent Application Publication
(10) Pub. No.: US 2011/0142179 A1
(43) Pub. Date: Jun. 16, 2011

(54) METHOD AND APPARATUS FOR GENERATING SOFT-DECISION INFORMATION BASED ON NON-GAUSSIAN CHANNEL IN WIRELESS COMMUNICATION SYSTEM

(75) Inventors: Kyungwhoon Cheun, Gyeongsangbuk-do (KR); Chang Kyu Seol, Seoul (KR)

(73) Assignee: POSTECH Academy-Industry Foundation, Pohang-si (KR)

(21) Appl. No.: 12/690,839

(22) Filed: Jan. 20, 2010

(30) Foreign Application Priority Data
Dec. 16, 2009 (KR) 10-2009-0125300

(51) Int. Cl. H04L 27/06

(52) U.S. Cl. 375/341

(57) ABSTRACT

A method and apparatus for generating soft-decision information based on non-Gaussian channel in a wireless communication system is provided. A receiver receives a decision variable, models an interference or noise distribution in the decision variable as a non-Gaussian probability density function and estimates a number of parameters of the non-Gaussian probability density function, and determines a log likelihood ratio (LLR) of the decision variable using the results of the estimation, wherein the parameters of the non-Gaussian probability density function comprise a shape parameter for determining the shape of the non-Gaussian probability density function.

### CROSS-REFERENCE TO RELATED APPLICATIONS

This application claims the benefit of Korean Patent Application No. 10-2009-0125300 filed on Dec. 16, 2009 which is incorporated by reference in its entirety herein.

### BACKGROUND OF THE INVENTION

1. Field of the Invention

The present invention relates to wireless communication, and more particularly, to a method and apparatus for generating soft-decision information based on non-Gaussian channel in a wireless communication system.

2. Related Art

In the meantime, modulation is a process for converting the level, phase, or frequency of signals according to the channel properties of a transmission medium for transmitting the signals. When appropriately modulated in consideration of the properties of a transmission medium, signals can be effectively transmitted over a long distance. More specifically, since data can be modulated over a wide band of frequencies, a variety of channels can be configured through modulation. In addition, the length of antennas can be reduced by increasing the frequency of signals through modulation. Moreover, various design requirements such as filtering or amplification can be satisfied through modulation. In this regard, modulation is deemed a process of converting data to a waveform suitable for a channel through which the data is to be transmitted.

Modulated data can be demodulated by a demodulator. The demodulator may generate hard- or soft-decision information for decoding data. A hard decision is a representation of the output of a demodulator as a binary value of 0 or 1 in order to represent a symbol received by the demodulator as one or more bits. On the other hand, a soft decision may be made when the output of the demodulator has a quantization level of 2 or greater. A soft decision on the output of the demodulator may be used to determine how much the symbol received by the demodulator deviates from its optimum position. The use of hard-decision information can simplify computation, and the use of soft-decision information can improve the performance of a receiver.

In the meantime, in order to generate soft-decision information, it is necessary to make an assumption on the statistical properties (i.e., a probability density function) of a channel through which data is transmitted. If a probability density function assumed by a receiver matches with the probability of a given channel, the receiver may be able to have optimum performance in the given channel. On the other hand, the more the probability density function assumed by the receiver deviates from the probability of the given channel, the poorer the performance of the receiver becomes. Therefore, in order to improve the performance of the receiver in the given channel, it is necessary to precisely determine the statistical properties of the given channel and then reflect the results of the determination in the development of various reception algorithms.

In general, soft-decision information may be generated based on the assumption of a Gaussian channel according to the central limit theorem. It is well known that, in a code division multiple access (CDMA) system, in particular, a multiple access interference distribution, which is a decision variable, can be modeled as a Gaussian distribution. However, from information theory's perspective, a Gaussian channel may not be a proper channel because there are interference distributions (such as an interference distribution in a multi-cellular orthogonal frequency-division multiple access (OFDMA) system) that can hardly be Gaussian.

If an optimum soft-decision information generation algorithm is applied to a non-Gaussian interference distribution such as an interference distribution in a multi-cellular OFDMA system, it is possible to considerably increase the capacity of a base station, compared to the case of using a typical Gaussian distribution-based soft-decision information generation algorithm. However, it is very complicated to realize an optimum reception algorithm for a non-Gaussian interference distribution.

Therefore, it is necessary to develop a soft-decision information generation algorithm which is easy to implement and is superior to a conventional Gaussian distribution-based soft-decision information generation algorithm.

### SUMMARY OF THE INVENTION

The present invention provides a method and apparatus for generating soft-decision information based on non-Gaussian channel in a wireless communication system.

In an aspect, a method for generating soft-decision information based on non-Gaussian channel in a wireless communication system is provided. The method includes receiving a decision variable, modeling an interference or noise distribution in the decision variable as a non-Gaussian probability density function and estimating a number of parameters of the non-Gaussian probability density function, and determining a log likelihood ratio (LLR) of the decision variable using the results of the estimation, wherein the parameters of the non-Gaussian probability density function comprise a shape parameter for determining the shape of the non-Gaussian probability density function. The parameters of the non-Gaussian probability density function may further comprise a scale parameter for determining the scale of the non-Gaussian probability density function. The interference or noise may be obtained by removing a symbol from the decision variable, the symbol being detected based on the decision variable. The estimating of the parameters of the non-Gaussian probability density function may comprise estimating the parameters of the non-Gaussian probability density function based on a moment of a random variable of the non-Gaussian probability density function. The determining of the LLR of the decision variable may comprise determining the LLR of the decision variable based on an Euclidean distance between the decision variable and the result of multiplying estimated channel information and a symbol detected from the decision variable.

In another aspect, a receiver in a wireless communication system is provided. The receiver includes a radio frequency (RF) unit for transmitting and receiving a radio signal, and a processor operatively coupled to the RF unit and configured to receive a decision variable, model an interference or noise distribution in the decision variable as a non-Gaussian probability density function, estimate a number of parameters of the non-Gaussian probability density function, and determine a log likelihood ratio (LLR) of the decision variable using the results of the estimation, the parameters of the non-Gaussian probability density function comprising a shape parameter for determining the shape of the non-Gaussian probability density function.

### BRIEF DESCRIPTION OF THE DRAWINGS

FIG. 1 illustrates a schematic diagram of a wireless communication system.

FIG. 2 illustrates a flowchart of a method for generating soft-decision information according to an exemplary embodiment of the present invention.

FIG. 3 illustrates a flowchart of a method for generating soft-decision information according to another exemplary embodiment of the present invention.

FIG. 4 illustrates a graph showing the performance of the soft-decision information generation methods of FIGS. 2 and 3.

FIG. 5 illustrates a block diagram of a receiver according to an exemplary embodiment of the present invention.

### DESCRIPTION OF EXEMPLARY EMBODIMENTS

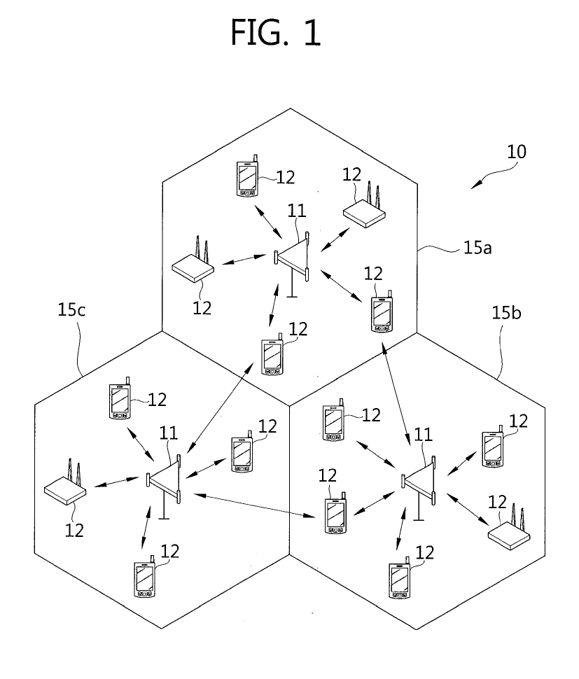

FIG. 1 illustrates a schematic diagram of a wireless communication system 10. Referring to FIG. 1, the wireless communication system 10 may include one or more base stations 11. The base stations 11 may provide a variety of communication services and may cover different geographic regions or cells 15a, 15b and 15c. Each of the cells 15a, 15b, and 15c may be divided into a plurality of sectors. The wireless communication system 10 may also include user equipment 12. The user equipment 12 may be fixed or mobile. The user equipment 12 may also be referred to as a mobile station, a mobile terminal, a user terminal, a subscriber station, a wireless device, a personal digital assistant (PDA), a wireless modem, or a handheld device. The base stations 11 may be fixed stations communicating with the user equipment 12. The base stations 11 may also be referred to as evolved-NodeBs (eNBs), base transceiver systems (BTS), or access points (APs).

The cell to which the user equipment 12 belongs may be referred to as a serving cell. A base station providing communication services throughout the serving cell may be referred to as a serving base station. Since the wireless communication system 10 is a cellular system, the serving cell may be adjoined by one or more other cells, which are referred to as neighbor cells. A base station providing services providing communication services throughout a neighbor cell may be referred to as a neighbor base station. In short, a cell may be classified into a serving cell or a neighbor cell according to whether the user equipment 12 belongs thereto.

The wireless communication system 10 can be applied to both a downlink and an uplink. A downlink corresponds to the transmission of data from the base stations 11 to the user equipment 12, and an uplink corresponds to the transmission of data from the user equipment 12 to the base stations 11. In the case of the downlink, some of the base stations 11 may serve as transmitters, and some of the user equipment 12 may serve as receivers. On the contrary, in the case of the uplink, some of the user equipment 12 may serve as transmitters, and some of the base stations 11 may serve as receivers.

A typical model for the reception of signals in the wireless communication system 10 may be represented by Equation 1.

Y=HS+Z [Equation 1]

Y indicates a decision variable representing the received data. H represents estimated channel information such as the effect of fading and carrier phase rotation. S represents a symbol. Z represents interference and background noise. In this exemplary embodiment, it is assumed that a receiver can precisely determine H through channel estimation.

As described above, there are various assumptions on the distribution of Z. It will hereinafter be described in detail how to generate soft-decision information based on the assumption that Z can be represented by a non-Gaussian probability density function.

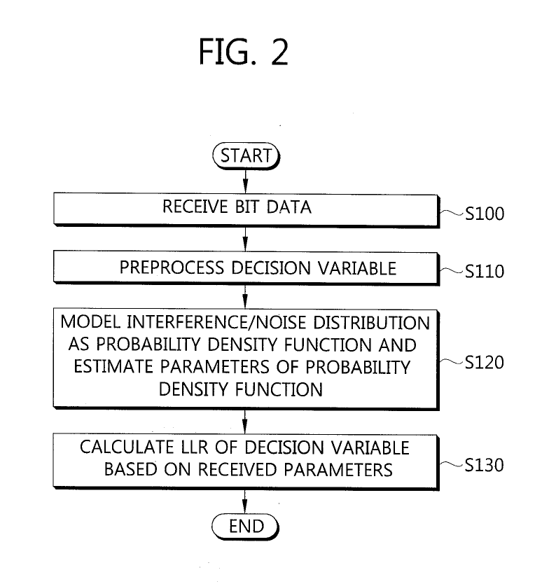

FIG. 2 illustrates a flowchart of a soft-decision information generation method according to an exemplary embodiment of the present invention. Referring to FIG. 2, a receiver may receive a decision variable (S100). The decision variable is generated by processing a received data. Thereafter, the receiver may preprocess the decision variable (S110). The preprocessing of the decision variable may be performed in order to estimate a number of parameters of a non-Gaussian probability density function.

More specifically, a symbol may be detected from the decision variable. Referring to Equation (1), the symbol Ŝ, which is an estimation of S, can be detected based on the decision variable Y and estimated channel information H. Since Y=HS+Z, a hard decision on Y/H may be made in order to detect Ŝ.

Thereafter, Z may be estimated by removing the symbol from the decision variable, as indicated by Equation 2.

\hat{Z}=Y−HŜ [Equation 2]

\hat{Z} refer to the estimate of Z. Referring to Equation 2, the interference and background noise Z may be estimated by subtracting the result of multiplying the estimated channel information H and the detected symbol Ŝ from the decision variable Y.

Thereafter, the receiver may model an interference or noise distribution in the decision variable as a non-Gaussian probability density function and may then estimate a number of parameters of the non-Gaussian probability density function (S120).

The non-Gaussian probability density function may have various types of distributions other than the Gaussian distribution. Part of the non-Gaussian probability density function may be generalized as a complex generalized Gaussian distribution (CGGD), as indicated by Equation 3.

$${f}_{\hat{Z}} ( z ) = \frac{α}{2 {πβ}^{2} Γ ( \frac{2}{α} )} exp ( - {( \frac{\vert z \vert}{β} )}^{α} ) \qquad [ Equation 3 ]$$

In Equation 3, \hat{Z} indicates a random variable, α indicates the shape parameter, β indicates a scale parameter for determining the scale of the non-Gaussian probability density function, and Γ(x) is a gamma function. The gamma function Γ(x) satisfies the following equation: Γ(x)( [symbol] ∫₀^{∞}t^{x-1}exp(−t)dt). The shape of the CGGD may vary in accordance with the shape parameter α. When α=2, the CGGD may have the Gaussian distribution. The width and height of the CGGD may vary in accordance with the scale parameter β. In this manner, the non-Gaussian probability density function can be defined simply using two parameters, i.e., the shape parameter β and the scale parameter β.

The parameters of the non-Gaussian probability density function may be estimated in various manners. For example, the shape parameter α and the scale parameter β may be estimated using an absolute moment of the random variable \hat{Z}. The absolute moment refers to a moment of an absolute value of a random variable. An n-th absolute moment of the random variable \hat{Z} may be represented by Equation 4.

$$E \{ {\vert \hat{Z} \vert}^{n} \} = {\int }_{0}^{2 π} {\int }_{0}^{∞} \frac{α {r}^{n}}{2 {πβ}^{2} Γ ( \frac{2}{α} )} exp ( - {( \frac{r}{β} )}^{α} ) r d r d θ \qquad [ Equation 4 ]$$

By substituting r with t [symbol] (r/β)^{α}, Equation 4 may be rearranged into Equation 5.

$$E \{ {\vert \hat{Z} \vert}^{n} \} = {β}^{n} Γ ( \frac{n + 2}{α} ) / Γ ( \frac{2}{α} ) \qquad [ Equation 5 ]$$

In order to estimate the shape parameter α, a first absolute moment and a second absolute moment of the random variable \hat{Z} may be determined. In order to eliminate β from Equation 5, the square of the first absolute moment of the random variable \hat{Z} may be normalized as the second absolute moment of the random variable \hat{Z}, as indicated by Equation 6.

$$\frac{{E}^{2} \{ \vert \hat{Z} \vert \}}{E \{ {\vert \hat{Z} \vert}^{2} \}} = \frac{{Γ ( \frac{3}{α} )}^{2}}{Γ ( \frac{2}{α} ) Γ ( \frac{4}{α} )} \approx \frac{{( \frac{1}{{N}_{s}} Σ \vert \hat{Z} \vert )}^{2}}{\frac{1}{{N}_{s}} Σ {\vert \hat{Z} \vert}^{2}} \qquad [ Equation 6 ]$$

In Equation 6, Nₛ indicate the number of quadrature amplitude modulation (QAM) symbols. By using Equation 6, the shape parameter α may be estimated. However, since Equation 6 includes a gamma function, the shape parameter α cannot be directly determined, but can be estimated using the following approximation formula: Γ(x)≈\sqrt{2π}x^{x-1/2}e^{-x}. More specifically, the shape parameter α can be estimated using Equation 7.

$$\begin{matrix}\hat{α} = \frac{ln ( {3}^{6} / {2}^{10} )}{ln ( \frac{{( \frac{1}{{N}_{s}} Σ \vert \hat{Z} \vert )}^{2}}{\frac{1}{{N}_{s}} Σ {\vert \hat{Z} \vert}^{2}} - \frac{π}{4} + {3}^{2} / {2}^{3.5} ) + ln ( 3 / 2 \sqrt{2} )} \\ = \frac{0.339798}{0.0588915 - ln ( \frac{{( \frac{1}{{N}_{s}} Σ \vert \hat{Z} \vert )}^{2}}{\frac{1}{{N}_{s}} Σ {\vert \hat{Z} \vert}^{2}} - 0.010097 )}\end{matrix} \qquad [ Equation 7 ]$$

The shape parameter α may be estimated by determining the moments of the absolute values of interference and noise in the decision variable and substituting the results of the estimation into Equation 7. Alternatively, since the estimation of the shape parameter α using Equation 7 is relatively complicated, the shape parameter α may be quantized, and may then be estimated using an moment expectation (E{|\hat{Z}|}²/E{|\hat{Z}|²})-shape parameter lookup table.

The scale parameter β may be estimated based on the shape parameter α. More specifically, referring to Equation 5, when n=1, the scale parameter β may be estimated by substituting α with \hat{α} and

$$E \{ \vert \hat{Z} \vert \} with \frac{1}{{N}_{s}} Σ \vert \hat{Z} \vert ,$$

as indicated by Equation (8):

$$\hat{β} = \frac{Γ ( 2 / \hat{α} )}{Γ ( 3 / \hat{α} )} \frac{1}{{N}_{s}} Σ \vert \hat{Z} \vert \qquad [ Equation 8 ]$$

Referring to FIG. 2, the receiver may calculate a log likelihood ratio (LLR) of the decision variable based on the shape parameter α and the scale parameter β (S130).

More specifically, the LLR of the decision variable may be calculated for a binary turbo or turbo-like decoder, as indicated by Equation 9.

$$L ( {b}^{λ} \vert Y = y , H = h ) = log \frac{{\sum }_{s ∈ {A}_{λ}^{0}} exp ( - {( \frac{\vert y - hs \vert}{β} )}^{α} )}{{\sum }_{s ∈ {A}_{λ}^{1}} exp ( - {( \frac{\vert y - hs \vert}{β} )}^{α} )} \qquad [ Equation 9 ]$$

where A_{λ}¹ indicates a set of log₂M-bit M-ary modulation symbols whose λ-th bit is 1, and A_{λ}⁰ indicates a set of log₂M-bit M-ary modulation symbols whose λ-th bit is 0.

Referring to Equation 9, the LLR of the decision variable may be calculated using an estimation of the shape parameter α and the scale parameter β. More specifically, the LLR of the decision variable may be calculated based on an Euclidian distance between a decision variable y and the result of multiplying estimated channel information h and any possible modulation symbol s.

Alternatively, when a max-log MAP turbo decoding algorithm is used, the LLR of the decision variable may be calculated using Equation 10.

$$\hat{L} ( {b}^{λ} \vert Y = y , H = h ) {min}_{s ∈ {A}_{λ}^{1}} {\vert y - hs \vert}^{α} - {min}_{s ∈ {A}_{λ}^{0}} {\vert y - hs \vert}^{α} \qquad [ Equation 10 ]$$

In Equation 10, A_{λ}¹ indicates a set of log₂M-bit M-ary modulation symbols whose λ-th bit is 1, and A_{λ}⁰ indicates a set of log₂M-bit M-ary modulation symbols whose λ-th bit is 0. Equation 10 requires only the shape parameter α in order to calculate the LLR of the decision variable, whereas Equation 9 requires both the shape parameter α and the scale parameter β. Thus, the calculation of the LLR of the decision variable may become simpler when using Equation 10 than using Equation 9. In the case of using Equation 10, like in the case of using Equation 9, the LLR of the decision variable may be calculated based on an Euclidian distance between the decision variable y and the result of multiplying the estimated channel information h and any possible modulation symbol s.

In the meantime, the calculation of the LLR of the decision variable based on |y−hs|^{α}, as indicated by Equation 9 or 10, may increase hardware complexity. In order to address this problem, |y−hs| or y may be divided into a number of sections, and |y−hs|^{α} or

$${min}_{s ∈ {A}_{λ}^{1}} {\vert y - hs \vert}^{α} - {min}_{s ∈ {A}_{λ}^{0}} {\vert y - hs \vert}^{α}$$

may be approximated as a linear function or a polynomial for each of the sections. In this manner, it is possible to reduce hardware complexity.

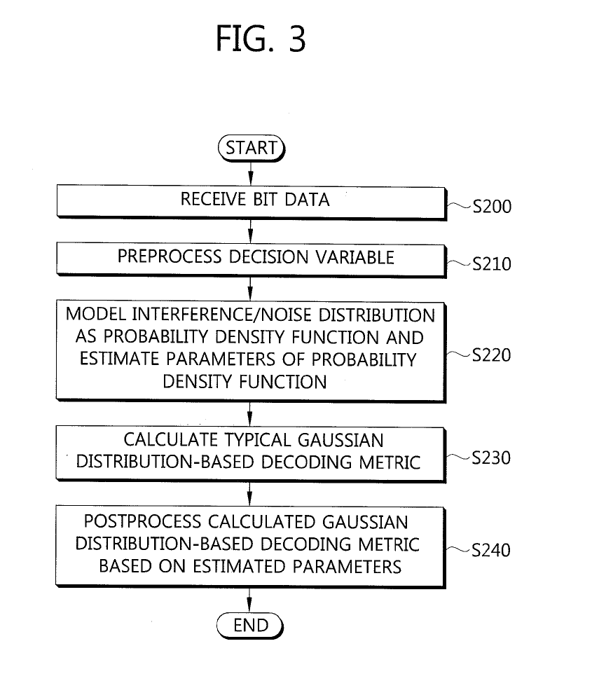

FIG. 3 illustrates a flowchart of a method for generating soft-decision information according to another exemplary embodiment of the present invention. Referring to FIG. 3, a receiver may receive a decision variable (S200). The decision variable is generated by processing a received data. Thereafter, the receiver may preprocess the decision variable (S210). As a result of the preprocessing performed in operation S210, a symbol may be detected from the decision variable. By removing the detected symbol from the decision variable, only interference and noise may be left in the decision variable.

Thereafter, the receiver may model an interference or noise distribution in the decision variable as a non-Gaussian probability density function, and may estimate a number of parameters of the non-Gaussian probability density function (S220). Thereafter, the receiver may calculate a Gaussian decoding metric based on the decision variable and estimated channel information (S230).

Thereafter, the receiver may postprocess the Gaussian decoding metric using the estimated parameters (S240).

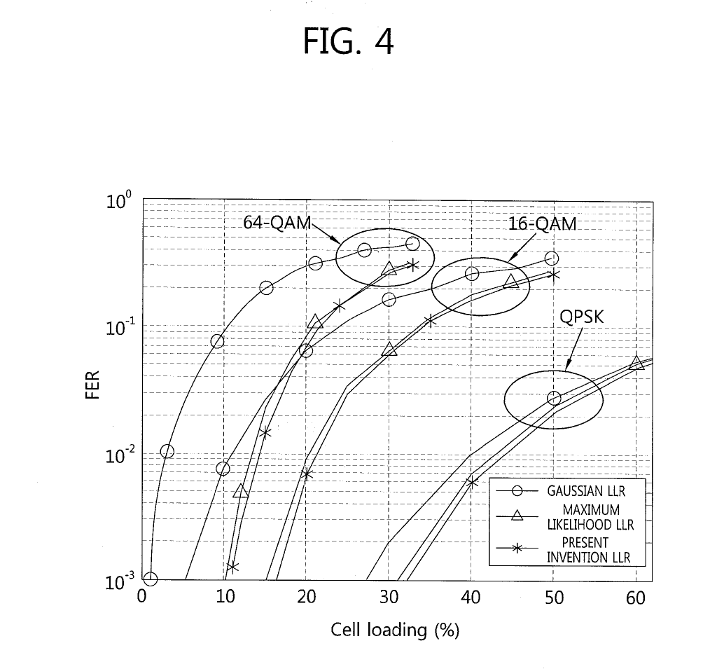

FIG. 4 illustrates a graph showing the performance of the soft-decision information generation methods of FIGS. 2 and 3. More specifically, FIG. 4 compares frame error rate (FER) measurements obtained using the soft-decision information generation method shown in FIG. 2 or 3 with FER measurements obtained using conventional soft-decision information generation methods. Referring to FIG. 4, in order to test for the performance of the soft-decision information generation method shown in FIG. 2 or 3, an simulation was conducted in an environment where there were twelve base stations with omnidirectional antennas, path loss decaying factor was 5, shadowing standard deviation was 10 dB, frequency-selective Rayleigh fading was used as a channel frequency response, various modulation methods such as quadrature phase shift keying (QPSK), 16-QAM, or 64-QAM were used, the length of information frames was 144 bits, code rate was ⅓ and log MAP decoding method was used.

Referring to FIG. 4, the term ‘cell loading’ indicates the ratio of the number of subcarriers used by each base station for the transmission of modulation symbols to a total number of sub-carrier waves available. The soft-decision information generation method shown in FIG. 2 or 3 can offer better performance than a conventional Gaussian method.

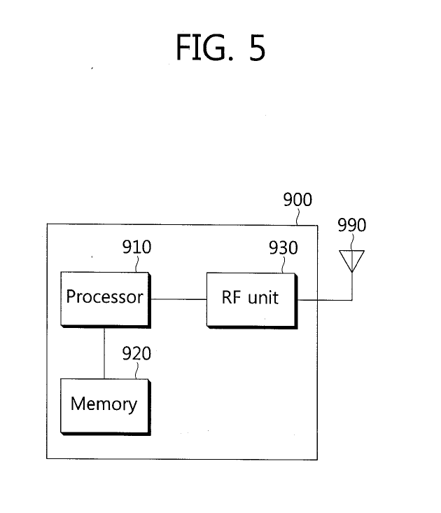

FIG. 5 illustrates a block diagram of a receiver 900 according to an exemplary embodiment of the present invention. Referring to FIG. 5, the receiver 900 may include a processor 910, a memory 920, and a radio frequency (RF) unit 930.

The processor 910 may be an embodiment of the soft-decision information generation method shown in FIG. 2 or 3. More specifically, the processor 910 may receive a decision variable, may model an interference or noise distribution in the decision variable as a non-Gaussian probability density function, may estimate a number of parameters of the non-Gaussian probability density function, and may determine the LLR of the decision variable using the results of the estimation. The parameters of the non-Gaussian probability density function may include a shape parameter for determining the shape of the non-Gaussian probability density function. A wireless interface protocol hierarchy may be realized by the processor 910. The memory 920 may be connected to the processor 910, and may store various information for driving the processor 910. The RF unit 930 may be connected to the processor 910, and may transmit or receive wireless signals.

Examples of the processor 910 include an application-specific integrated circuit (ASIC), a chip set, a logic circuit and a data processor. Examples of the memory 920 include a read-only memory (ROM), a random access memory (RAM), a flash memory, a memory card, and a storage medium. The RF unit 930 may include a baseband circuit for processing wireless signals. The soft-decision information generation method shown in FIG. 2 or 3 may be realized as one or more software modules. In this case, the software modules may be stored in the memory 920 and may be able to be executed by the processor 910. The memory 920 may be included in the processor 910 or may be disposed outside the processor 910. The memory 920 may be connected to the processor 910 in various manners.

As described above, according to the present invention, it is possible to improve channel decoding performance. In addition, the present invention can increase cell capacity especially when applied to an OFDMA downlink network with a plurality of terminals.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the spirit and scope of the appended claims.

What is claimed is:

1. A method for generating soft-decision information based on non-Gaussian channel in a wireless communication system, the method comprising:
receiving a decision variable;
modeling an interference or noise distribution in the decision variable as a non-Gaussian probability density function and estimating a number of parameters of the non-Gaussian probability density function; and
determining a log likelihood ratio (LLR) of the decision variable using the results of the estimation,
wherein the parameters of the non-Gaussian probability density function comprise a shape parameter for determining the shape of the non-Gaussian probability density function.

2. The method of claim 1, wherein the parameters of the non-Gaussian probability density function further comprise a scale parameter for determining the scale of the non-Gaussian probability density function.

3. The method of claim 1, wherein the non-Gaussian probability density function is represented by the following equation:
$${f}_{\hat{Z}} ( z ) = \frac{α}{2 {πβ}^{2} Γ ( \frac{2}{α} )} exp ( - {( \frac{\vert z \vert}{β} )}^{α} )$$
where \hat{Z} indicates a random variable, α indicates the shape parameter, β indicates a scale parameter for determining the scale of the non-Gaussian probability density function, and Γ(x) is a gamma function, the gamma function Γ(x) satisfying the following equation: Γ(x)( [symbol] ∫₀^{∞}t^{x-1}exp(−t)dt).

4. The method of claim 1, wherein the interference or noise is obtained by removing a symbol from the decision variable, the symbol being detected based on the decision variable.

5. The method of claim 1, wherein the estimating of the parameters of the non-Gaussian probability density function comprises estimating the parameters of the non-Gaussian probability density function based on a moment of a random variable of the non-Gaussian probability density function.

6. The method of claim 1, wherein the determining of the LLR of the decision variable comprises determining the LLR of the decision variable based on an Euclidean distance between the decision variable and the result of multiplying estimated channel information and a symbol detected from the decision variable.

7. The method of claim 6, wherein the determining of the LLR of the decision variable further comprises determining the LLR of the decision variable using the following equation:
$$L ( {b}^{λ} \vert Y = y , H = h ) = log \frac{{\sum }_{s ∈ {A}_{λ}^{0}} exp ( - {( \frac{\vert y - hs \vert}{β} )}^{α} )}{{\sum }_{s ∈ {A}_{λ}^{1}} exp ( - {( \frac{\vert y - hs \vert}{β} )}^{α} )}$$
where Y indicates the decision variable, H indicates estimated channel information, α indicates the shape parameter, β indicates a scale parameter for determining the scale of the non-Gaussian probability density function, A_{λ}¹ indicates a set of log₂M-bit M-ary modulation symbols whose λ-th bit is 1, and A_{λ}⁰ indicates a set of log₂M-bit M-ary modulation symbols whose λ-th bit is 0.

8. The method of claim 6, wherein the determining of the LLR of the decision variable further comprises determining the LLR of the decision variable using the following equation:
$$\hat{L} ( {b}^{λ} \vert Y = y , H = h ) {min}_{s ∈ {A}_{λ}^{1}} {\vert y - hs \vert}^{α} - {min}_{s ∈ {A}_{λ}^{0}} {\vert y - hs \vert}^{α}$$
where Y indicates the decision variable, H indicates estimated channel information, α indicates the shape parameter, β indicates a scale parameter for determining the scale of the non-Gaussian probability density function, A_{λ}¹ indicates a set of log₂M-bit M-ary modulation symbols whose λ-th bit is 1, and A_{λ}⁰ indicates a set of log₂M-bit M-ary modulation symbols whose λ-th bit is 0.

9. The method of claim 7, wherein the determining of the LLR of the decision variable further comprises dividing |y−hs| into a number of sections and approximating |y−hs|^{α} as a linear function or a polynomial for each of the sections.

10. The method of claim 8, wherein the determining of the LLR of the decision variable further comprises dividing |y−hs| into a number of sections and approximating |y−hs|^{α} as a linear function or a polynomial for each of the sections.

11. The method of claim 7, wherein the determining of the LLR of the decision variable further comprises dividing y into a number of sections and approximating |y−hs|^{α} as a linear function or a polynomial for each of the sections.

12. The method of claim 8, wherein the determining of the LLR of the decision variable further comprises dividing y into a number of sections and approximating |y−hs|^{α} as a linear function or a polynomial for each of the sections.

13. The method of claim 8, wherein the determining of the LLR of the decision variable further comprises dividing y into a number of sections and approximating
$${min}_{s ∈ {A}_{λ}^{1}} {\vert y - hs \vert}^{α} - {min}_{s ∈ {A}_{λ}^{0}} {\vert y - hs \vert}^{α}$$
as a linear function or a polynomial for each of the sections.

14. A receiver in a wireless communication system, the receiver comprising:
a radio frequency (RF) unit for transmitting and receiving a radio signal; and
a processor operatively coupled to the RF unit and configured to:
receive a decision variable,
model an interference or noise distribution in the decision variable as a non-Gaussian probability density function,
estimate a number of parameters of the non-Gaussian probability density function, and
determine a log likelihood ratio (LLR) of the decision variable using the results of the estimation,
the parameters of the non-Gaussian probability density function comprising a shape parameter for determining the shape of the non-Gaussian probability density function.
